(19) United States
(12) Patent Application Publication
(10) Pub. No.: US 2008/0265625 A1
(43) Pub. Date: Oct. 30, 2008

(54) Truck Comprising a Rope-Operated Tilting Device for the Cab

(75) Inventor: Mario List, Remseck (DE)

Correspondence Address: CROWELL & MORING LLP;INTELLECTUAL PROPERTY GROUP, P.O. BOX 14300, WASHINGTON, DC, 20044-4300, US

(73) Assignee: Daimier AG, Stuttgart (DE)

(21) Appl. No.: 11/996,458

(22) PCT Filed: Jul. 12, 2006
(86) PCT No.: PCT/EP2006/006798

§ 371 Date: Jul. 10, 2008

(30) Foreign Application Priority Data
Jul. 23, 2005 (DE) 10 2005 034 463.1

(51) Int. Cl. B62D 33/063

(52) U.S. Cl. 296/190.06

(57) ABSTRACT

A truck has a cab that is hinged to a chassis via a bearing about a rotational shaft. A tilting device is provided for raising the cab into a forward-tilted open position for access to the engine compartment located thereunder, and the cab is able to be fixed in the closed position to the chassis. The tilting device includes at least one tractive element that may be actuated via a drive for raising and closing the cab. The tractive element is mounted between the cab and the chassis such that in the case of a head-on collision with an obstruction, level with the cab, it forms a catching device for the cab.

### BACKGROUND AND SUMMARY OF THE INVENTION

This invention relates to a truck comprising a cab which is hinged to a chassis via a bearing about a rotational shaft, and which may be adjusted via a tilting device into a forward-tilted open position. By tilting the cab, access is permitted to the region located thereunder, in particular to the engine, for repair and maintenance operations. In the closed position of the cab, in addition to the tilting bearing, damping and spring systems are effective between the cab and the chassis, in order to ensure the comfort of the driver.

To implement the tilting function, hydraulic tilting systems are known that, by means of a hydraulic cylinder, hydraulic pipes and a pump, permit raising of the cab. The hydraulic elements have to be installed and arranged in the region below the cab. These hydraulic tilting systems are thus costly in terms of construction and assembly and have a relatively large spatial requirement. Therefore, as a result of the hydraulic systems, there are considerable restrictions for the design and arrangement of components in the intermediate space between the cab and the chassis. During a head-on collision of the truck, level with the cab, the rigidly mounted hydraulic components are generally destroyed when the cab is pulled off its bearing and displaced to the rear relative to the chassis. Thus damaging aftereffects also occur due to the leakage of hydraulic fluid. Repairing the tilting system is in such a case cost-intensive and normally requires the complete replacement of the damaged components of the tilting device.

The invention relates, in particular, to such a truck which is better protected even with regard to possible damage to the sides of the cab and the tilting device during head-on collisions. When the truck hits an obstruction ahead, level with the cab, such as for example a platform trailer of a truck driving ahead, there is the risk of the bearing being pulled off and of considerable damage to the cab by the collision energy to be absorbed. More specifically, the connection points of the cab are generally configured to be too weak in known trucks to retain the cab on the chassis in such a case. As the kinetic energy introduced by the impact, therefore, is not able to be diverted into the chassis which is designed to be more stable, the entire crash energy is absorbed by the cab and destroyed by deformations and/or the displacement thereof to the rear. Not infrequently, this leads to the complete destruction of the cab and involves the risk of greater injuries for the driver.

The object of the invention, therefore, is to propose a truck with a tilting device that is structurally more simple and more resistant relative to collisions, and which is optimized with regard to the energy absorption in head-on collisions, level with the cab, and the protection of the passengers.

This object is achieved by a truck with the features claimed. Advantageous embodiments and developments form subject matter that is also claimed.

The truck according to the invention comprises a cab, which is hinged via a bearing to a chassis about a rotational shaft, with a tilting device for raising the cab into a forward-tilted open position for access to the engine compartment located thereunder. The cab is able to be fixed in the closed position to the chassis, and the tilting device comprises at least one tractive element which may be actuated via a drive for raising and closing the cab which is mounted between the cab and the chassis, such that in the case of a head-on collision with an obstruction, level with the cab, it forms a catching device for the cab. The tilting device thus comprises a mechanical tractive element, such as for example a chain, a cable or a belt which may be retracted or released via a drive. The tractive element has the advantage that, in comparison with hydraulic systems, it requires a small installation space. Greater freedom in the construction and arrangement of components is therefore provided in the intermediate space between the cab and the chassis. Moreover, in addition to tilting the cab, the tractive element undertakes the function of a catching device for the cab in the event of a crash. The tractive element is mounted between the chassis and the cab in such a manner that, if the bearing is pulled off, the cab is nevertheless securely fixed. The tractive element holds the cab on the chassis and at least partially converts the kinetic energy of the impact as a result of a specific longitudinal extension. The main portion of the energy is diverted into the chassis of the truck. The tilting device formed from at least one tractive element according to the invention thus undertakes a dual function of allowing the tilting adjustment and the fixing of the cab to the chassis in the event of a crash. As, due to the tractive element, the complete release of the cab is prevented, excessive damage to the cab is avoided. The tractive element is itself, moreover, not susceptible as regards damage in the event of an accident, as it is designed for a corresponding tensile strain and allows a specific relative displacement between the cab and the chassis without being damaged, as would be the case with rigid connections. The tilting device according to the invention is, in particular, environmentally friendly as it requires no hydraulic fluid. It may be fitted in a space-saving manner, in particular even in side regions of the truck.

According to an advantageous embodiment of the invention, for tilting the cab, a first tractive element is provided and is connected to a front portion of the cab. For closing the cab, a second tractive element is provided and is connected to a rear portion of the cab. For carrying out the tilting motion, the first tractive element is actuated by a corresponding drive, so that the cab is pulled down from the front about the rotational shaft and tilted. In reverse, for closing the cab, a second tractive element is subjected to a load and is fastened to a rear portion of the cab, and thus pulls the cab down again. The tractive elements which are not actuated respectively yield during tilting and closing so that a respective opening and/or closing of the cab is allowed by releasing a corresponding length of the tractive elements. The first and also the second tractive element form in the closed position of the cab a catching device which anchors the cab on the front side and on the rear side to the chassis. To this end, the tractive elements are respectively fixed to the chassis, so that they act against a displacement of the cab during a collision. As a result, a secure multipoint anchoring for catching the cab is provided, and the loads are distributed onto the front and the rear tractive elements.

According to a further advantageous embodiment of the invention, a tractive element to the front in the direction of travel is substantially horizontally aligned along the vehicle longitudinal axis, and a rear tractive element is aligned substantially vertically between the cab and the chassis of the truck. The loading directions of the tractive elements are therefore perpendicular relative to one another and are optimized for the functions of tilting and/or closing the cab. The horizontal tractive element extending to the front is fastened below the rotational shaft of the tilting bearing for tilting the cab. The vertically aligned tractive element is preferably fastened in the rear region respectively to the cab and the chassis. The necessary actuating forces of the drives of the tractive elements are thereby reduced, as they are located in an alignment and position which is respectively adapted to the function.

According to an aspect of the invention relative thereto, the tractive element aligned horizontally along the vehicle longitudinal axis may be fixed in the front region of the chassis, so that in the event of a displacement of the cab to the rear it is tension-loaded by the cab by a deflection in the direction of its alignment. Thus the tractive element aligned to the front and horizontally may, due to its fixing and deflection, also retain the cab in the event of a crash. The load situations of tilting and fixing in the event of a crash, which oppose one another in the active direction, may in this manner be overcome by one and the same tractive element. The tilting device is, however, of extremely simple design in its construction and requires, for the catching function, no additional connections between the cab and the chassis.

According to a further advantageous embodiment of the invention for the tractive elements, respective separate drives are provided and are controlled in a manner where they are mutually adjusted via a common control for tilting and closing the cab. The actuation of the tractive elements is thus mutually adapted and the tractive element which is respectively not tension-loaded is synchronously released to a corresponding length for actuating the other tractive element, without being completely released. The tractive elements are thus always in a pretensioned state, and the arrangement does not result in one of the tractive elements hanging loose.

According to a further advantageous embodiment of the invention, a fixing device is provided for non-positively or positively securing the free length of the at least one tractive element in the closed position of the cab. By securing the free length of the tractive elements, the extension behavior thereof and thus the effectiveness as a catching device are determined. With a greater free length of the tractive elements, the tractive elements may be deformed to a greater extent and may absorb greater amounts of energy in the event of a crash. The securing of the free length of the tractive elements and thus the extensibility thereof leads to a controlled pulling back of the cab in the event of a head-on collision which involves an at least partial destruction of the energy introduced. The remaining kinetic energy is then deflected by the tractive elements to the more stable structure of the chassis.

The fixing devices may be implemented in the form of clamping jaws, clamping sleeves or the like.

The fixing device may, according to a further aspect of the invention, preferably be set to a predetermined threshold for yielding in the event of large collision forces. Such a flexible fixing device has the advantage that, even with large forces, the tractive elements of the tilting and catching device do not tear, so that permanent damage thereof is prevented.

According to a further advantageous embodiment of the invention, a downwardly projecting L-shaped coupling part is provided in the region of the rotational shaft of the bearing of the cab to which the tractive element of the tilting device is connected. As a result, complicated deflections of the tractive element are avoided as a point of application is provided below the rotational shaft for a tilting movement introduced by tractive force. The L-shaped coupling part forms a type of lever about the rotational shaft of the tilting bearing and is itself fixedly connected to the cab. As a result of the downwardly displaced connection of the tractive element, the tractive element may be aligned in a horizontal plane along the chassis, so that the fixing for the closed position may also be mounted in this region.

According to a further advantageous embodiment of the invention, the at least one tractive element and the respective drive are mounted on a longitudinal member of the chassis. The longitudinal members of the chassis represent a highly stable anchoring point for the function of the tractive elements as a catching device. Moreover, the drives and the fastenings of the tractive elements in this case may, in a simple manner, be directly arranged on the chassis, and require no additional subassemblies, such as supports, retaining plates or the like. An effective absorption and introduction of collision forces is ensured by the direct mounting on the longitudinal members.

According to a further advantageous embodiment of the invention, the at least one tractive element is a bracing cable wound on a drum. The bracing cable, for example, may be a steel cable of suitable strength, and forms together with the drum and a drive of the drum a cable traction device. By having the bracing cable wound onto a drum, a simply constructed mechanical tilting device with a catching function is provided in the event of a crash. The release and retraction of the bracing cable for the functions of tilting and closing the cab are implemented by rotating the cable drum via corresponding motorized drives. The cables and the drums thereof are not very susceptible to damage, even in the case of more extreme loads. The tilting/catching function according to the invention is ensured by the same flexible cables between the cab and the chassis.

According to a further advantageous embodiment of the invention, the at least one tractive element is adjusted in its extensibility for catching the cab in the event of a collision. This means in the present case that the tractive element has a sufficient extensibility, so that in the event of a crash it is able to yield but not tear. The specific extensibility allows a controlled pulling back of the cab relative to the chassis. By the extension of the tractive element, the kinetic energy of the impact is substantially reduced by deformation. The extensibility of the tractive element is, for example, adjusted depending on the weight, the intensity of front collision forces, normal load situations and the number of tractive elements.

Further advantages and features of the invention may be taken from the following detailed description, in which the invention is described in more detail relative to the embodiment shown in the accompanying drawings.

### BRIEF DESCRIPTION OF THE DRAWINGS

FIG. 1 shows a schematic side view of an embodiment of a truck according to the invention with a cable-operated tilting device when the cab is closed;

FIG. 2 shows a schematic side view of the embodiment of FIG. 1 in the tilted position of the cab; and

FIG. 3 shows a schematic side view of the embodiment of FIGS. 1 and 2 after a front collision to illustrate the catching function.

### DETAILED DESCRIPTION OF THE INVENTION

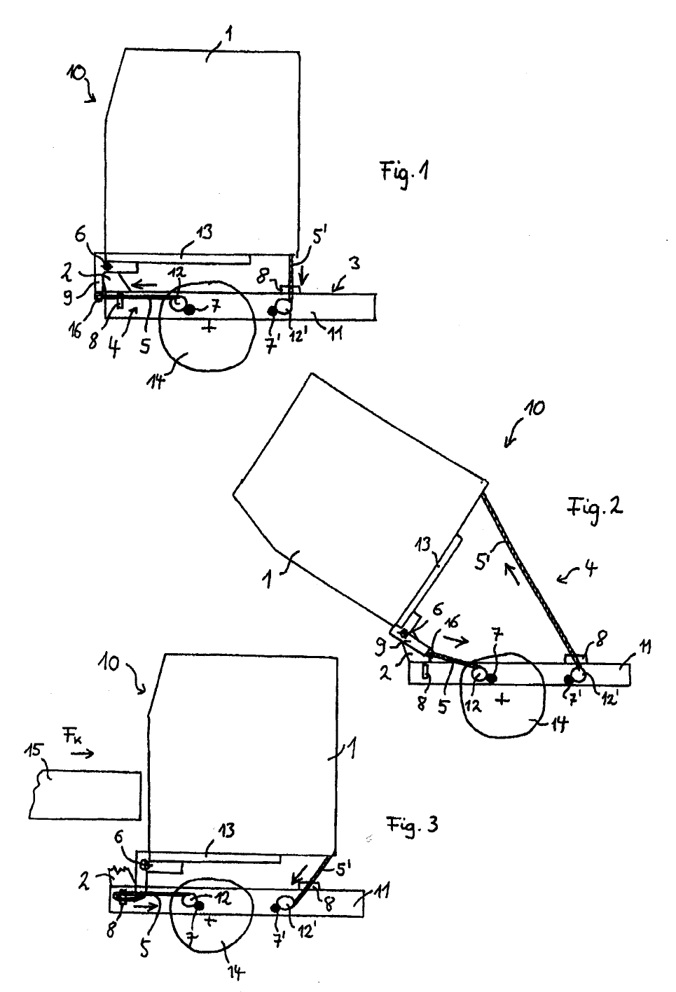

An embodiment of a truck 10 according to the invention is shown in FIG. 1 with the cab 1 in the closed position in normal driving operation in a schematic side view. Between the cab 1 and a chassis 3, a tilting device 4 is provided by means of which the cab 1 may be upwardly tilted about a rotational shaft 6 of a bearing 2. The cab 1 is thus at the front end hinged to a bearing 2 in the form of an upwardly projecting bearing block which in turn is fixedly fastened to a longitudinal member 11 of the chassis 3. The cab 1 is reinforced at its lower end with lateral longitudinal members 13. In addition to the conventional connection of the cab 1 via the bearing 2, a tilting device 4 according to the invention is provided and consists of a front cable 5 and a rear cable 5′ which respectively may be actuated via cable drums 12, 12′. The cable drums 12, 12′ are fastened to the longitudinal member 11 of the chassis 3 and respectively provided with a drive 7, 7′ for releasing and retracting the cables 5, 5′. The cab 1 may in this manner, by actuating the drives 7, 7′, be tilted forward from its closed position shown about the rotational shaft 6 by the front cable 5 being retracted and at the same time the rear cable 5′ being released to the corresponding length. The front cable 5 is connected by means of a connection 16 to an L-shaped coupling part 9 to the front side of the cab 1, whilst the rear cable 5′ with its free end is fastened to a portion of the cab 1 to the rear in the direction of travel. The tilting device 4 consisting of the tractive cables 5, 5′ forms in this manner and at the same time a catching device for the cab 1 in the event of a crash, as a result of which the cab is also securely held on the chassis 3 even when the bearing 2 is damaged and pulled off. In the normal driving situation of the truck 10 shown, the cables 5, 5′ are fixed in their lengths via one respective fixing device 8. The fixing devices 8 may be released for the tilting function. The fixing device 8 is, for example, implemented via a non-positive or positive retention of the cables 5, 5′. It is only possible to compensate for the spring deflection path and the spring extension path of the cab 1 about the bearing 2 by the cables 5, 5′ which, for example, is achieved by a specific extensibility of the cables 5, 5′ or even by free lengths of cable for the spring path.

The L-shaped coupling part 9, to which the front cable 5 is fastened, at the same time produces the connection with the bearing 2. The rotational shaft 6 of the bearing 2 passes through the coupling part 9, with a downwardly projecting portion of the coupling part 9 reaching as far as the region of the chassis 3. As a result, the front cable 5 may be substantially aligned in the longitudinal direction of the longitudinal member 11, and nevertheless cause a tilting actuation of the cab 1 as a result of a tractive force. The front cable 5 is fastened to the coupling part 9 via a connection 16 in the form of an annular element, whereby it is rotatably mounted for the tilting function. The fastening of the front bracing cable 5 to the chassis 3 is located in approximately the center of the longitudinal member 11 under the cab 1 in the region of a front wheel 14, so that a sufficient adjusting path of the cable 5 is provided for tilting the cab 1. In the embodiment shown, two separate cables 5, 5′ are provided with separate drives 7, 7′. However, a continuous and/or peripheral tractive element with only one drive may also be provided, which is respectively fastened to the front side and rear side of the cab. The rear cable 5′ may alternatively be fastened, for the direct fastening to the cab 1, shown, to the longitudinal member 13 of the cab, which has a greater rigidity and thus allows a greater absorption and improved transmission of forces in the event of a collision.

FIG. 2 illustrates the tilting function of the tilting and catching device according to the invention with tractive cables 5, 5′. Firstly, the fixings 8 for releasing the cables 5, 5′ are released. Then the cable drum 12 is actuated via the drive 7, so that the cable 5 is wound up. The shortening of the cable 5 causes a tilting of the cab 1 about the rotational shaft 6. In this case, the rear cable 5′ is released from the cable drum 12′ to the required length. If the cab 1 is intended to be tilted back into the drive position again, the rear cable 5′ is wound onto its drum 12′ and thus tension-loaded. In order to avoid a sudden tilting back, a common control of the drives 7, 7′ is provided. The cables 5, 5′ which are respectively not active as traction cables, are released by the control only to the corresponding required length, without being fully released. If the cab 1 is again in its driving position on the chassis 3, the fixing devices 8 are activated again. Thus the tilting device 4 again fulfills its function as a collision catching device for the cab 1, which is active during driving. The figures only show one side of the truck 10. It is understood, however, that a corresponding tilting device 4 is also provided on the opposing side of the cab 1. Thus a flexible mechanical 4-point holding element of the cab 1 is provided. The tilting device 4 is, as a result of the tractive elements 5, 5′, particularly space-saving and requires no hydraulic components which are structurally complicated and susceptible to damage, as are provided with such conventional tilting devices.

FIG. 3 shows by way of example a crash situation of the truck 10. In a head-on collision of the truck 10 with an obstruction ahead, level with the cab 1, such as for example a platform trailer 15 of a truck driving in front, considerable collision forces F_{K} act on the cab, and the kinetic energy thereof has to be absorbed by the cab 1. The tilting bearing 2 of the cab 1 may in such a case generally not resist the forces and breaks off. Therefore, with conventional trucks, the cab which does not have a fixing is displaced to the rear, counter to the direction of travel, as it is no longer held on the chassis. In order to prevent this, the tilting and catching device according to the invention 4 is implemented with cables 5, 5′ which, after the bearing 2 is pulled off, hold back the cab 1. Cables are namely highly rigid structural elements and have a defined extensibility which comes to bear when catching the cab 1. The cables 5, 5′ of the tilting device 4 are fixed to the chassis 3 via fixing devices 8, so that the cable drums 12, 12′ when loaded may not be damaged and the cables 5, 5′ are tension-loaded only in the portion between the fixings 8 and the fastening points on the cab 1.

The free length of the cables 5, 5′ and thus also the extensibility of the catching device is defined by means of the fixing devices 8. Instead of providing a rigid connection, the cables 5, 5′ allow a controlled pulling back of the cab 1, without the connection to the chassis 3 located thereunder being lost. Both cables 5, 5′ are thus tension-loaded, and convert the kinetic energy partially by extension and/or deflect that energy into the more stable region of the chassis 3. The fixing devices 8, on which the cables 5, 5′ are held, may therefore be implemented also as flexible devices which fail beyond a predetermined threshold force. As a result, the tilting device 4 is not destroyed and/or the cables 5, 5′ tear at very high forces. The cables 5, 5′ are, for example, highly rigid steel cables which together with the cable drums 12, 12′ form respective cable traction devices. The fixing device 8 of the front cable 5 is fastened to the front end of the longitudinal member 11. The cable 5 is moved in the direction of its length, in the event of a crash, as may be seen in FIG. 3, and is secured by the fixing device 8 in the form of a 180° deflection on the longitudinal member 11.

As a result of its low spatial requirement, the tilting device 4 according to the invention offers greater freedom with regard to the construction and arrangement of components in the region under the cab 1. It is similarly reliable in operation and environmentally friendly. Damage as a result of leaking hydraulic fluid from a hydraulic circuit after an accident is avoided. Moreover, in addition to the tilting function, it fulfills an additional safety function as a catching device in the event of head-on collisions of the truck, whereby the damage at the side of the cab is minimized.

All features and elements shown in the description, the following claims as well as features and elements shown in the drawings, may be essential to the invention both individually and in any combination.

1-11. (canceled)

12. A truck comprising:
a cab which is hinged to a chassis via a bearing about a rotational shaft, and
a tilting device for raising the cab into a forward-tilted open position for access to the engine compartment located thereunder,
wherein the cab is fixable in a closed position to the chassis, and
wherein the tilting device includes at least one tractive element that may be actuated via a drive for raising and closing the cab that is mounted between the cab and the chassis such that, in a head-on collision with an obstruction level with the cab, the tractive element forms a catching device for the cab.

13. The truck as claimed in claim 12, wherein the at least one tractive element includes first and second tractive elements, wherein the first tractive element is provided for tilting the cab and is connected to a front portion of the cab, and wherein the second tractive element is provided for closing the cab and is connected to a rear portion of the cab.

14. The truck as claimed in claim 13 wherein the first tractive element is located to the front in the direction of travel and is substantially horizontally aligned along the vehicle longitudinal axis, and wherein the second tractive element is a rear tractive element aligned substantially vertically between the cab and the chassis.

15. The truck as claimed in claim 14, wherein the first tractive element may be fixed in the front region of the chassis so that, in the event of a displacement of the cab to the rear, it is tension-loaded by the cab by a deflection in the direction of its alignment.

16. The truck as claimed in claim 13, wherein separate drives are provided for the tractive elements, and wherein the drives are controlled so that they are mutually adjusted via a common control for tilting and closing the cab.

17. The truck as claimed in claim 12, further comprising a fixing device provided for non-positively or positively securing a free length of the at least one tractive element in the closed position of the cab.

18. The truck as claimed in claim 17, wherein the at least one tractive element is secured via a fixing device that is set to a predetermined threshold for yielding in the event of large collision forces.

19. The truck as claimed in claim 12, wherein a downwardly projecting L-shaped coupling part is provided in a region of the rotational shaft of the bearing of the cab to which the at least one tractive element is connected.

20. The truck as claimed in claim 16, wherein at least one of the tractive elements and its respective drive are mounted on a longitudinal member of the chassis.

21. The truck as claimed in claim 12, wherein the at least one tractive element is a cable wound onto a drum.

22. The truck as claimed in claim 12, wherein the at least one tractive element is adjusted in extensibility for catching the cab in the event of a collision.

23. The truck as claimed in claim 14, wherein separate drives are provided for the tractive elements, and wherein the drives are controlled so that they are mutually adjusted via a common control for tilting and closing the cab.

24. The truck as claimed in claim 15, wherein separate drives are provided for the tractive elements, and wherein the drives are controlled so that they are mutually adjusted via a common control for tilting and closing the cab.

25. The truck as claimed in claim 17, wherein the at least one tractive element is a cable wound onto a drum.

26. The truck as claimed in claim 17, wherein the at least one tractive element is adjusted in extensibility for catching the cab in the event of a collision.
